(19) United States
(12) Patent Application Publication
(10) Pub. No.: US 2017/0039877 A1
(43) Pub. Date: Feb. 9, 2017

(54) AUTOMATED DETERMINATION OF APTITUDE AND ATTENTION LEVEL BASED ON USER ATTRIBUTES AND EXTERNAL STIMULI

(71) Applicant: International Business Machines Corporation, Armonk, NY (US)

(72) Inventors: FEDERICO TOMAS GIMENEZ MOLINELLI, BUENOS AIRES (AR); NICOLAS ORLANDO NAPPE, BUENOS AIRES (AR); GASTON ALEJO RIUS, BUENOS AIRES (AR); NICOLAS TCHERECHANSKY, BUENOS AIRES (AR); FACUNDO JAVIER TOMASELLI, BUENOS AIRES (AR); NICOLAS MARIO JOSE TORCASIO, BUENOS AIRES (AR)

(21) Appl. No.: 14/820,920

(22) Filed: Aug. 7, 2015

(51) Int. Cl. G09B 19/00; G09B 5/02; G09B 5/00

(52) U.S. Cl. CPC G09B 19/00; G09B 5/00; G09B 5/02

(57) ABSTRACT

Aspects automatically determine aptitude or attention level of a user as a function of time of day, user attributes and external stimuli. Impact values are determined relative to user aptitude from stimulus associated with event activity as a function of user attributes that include levels of attention, rest and experienced stress. The impact values have a negative sign if beneficial to the user aptitude, or a positive sign if detrimental. Baseline time adjustment factors are selected to match user demographic data and event activity time or duration. A time shift value is determined as a sum of the impact values. An effective time of day value is determined by adding the time shift value to the baseline time adjustment factors of matching time values. An effective time of day is generated by adding the determined effective time of day value to a current time of day.

### BACKGROUND

Users rely on personal programmable devices such as personal digital assistants (PDA's), smart phones, smart watches, smart glasses and other mobile devices to coordinate and manage appointments, agendas, meetings, to-do lists, work product events and other interactions. Such devices enable a wide range of communication mediums and different associated audio and visual notifications of alerts, scheduled or pending or requested appointment times, incoming text, email and voice messaging from others, etc.

Mobile devices present a variety of user setting configurations that enable selective filtering of alerts, calls or messages based on user settings, preferences and modes. For example, a user may select a “Do not disturb” mode that silences most or all incoming calls, messages or alerts until the mode is unselected or terminated by a manual input of the user, or at a predefined time, such as the beginning of a workday. Spam filter settings may prevent excess messaging reception and alerts. Privacy settings may specify designated subsets of possible originating persons or entities (companies, organizations, domains, etc.).

### BRIEF SUMMARY

In one aspect of the present invention, a method for the automated determination of aptitude or attention level of a user as a function of time of day based on user attributes and external stimuli includes determining an impact value relative to an aptitude of a user from a stimulus associated with an event activity that has a time of occurrence and a time duration, as a function one or more of current attributes of the user that include a level of attention, a level of rest and a level of experienced stress. The impact value is assigned a negative sign if beneficial to the user aptitude, or a positive sign if detrimental to the user aptitude. One or more baseline time adjustment factor are selected from a database that each match demographic data of the user and a time value of the event activity time occurrence or the time duration. A time shift value is determined as a sum of all impact values that are determined relative to the aptitude of the user from stimuli associated with event activities having the time of occurrence or the time duration. An effective time of day value is determined for a current time period of the user that is within the time of occurrence or the time duration by adding the determined time shift value to each of the baseline time adjustment factors that match time values within the current time period of the user. Thus, an effective time of day is generated for a current time of day of the user by adding the determined effective time of day value to the current time of day of the user.

In another aspect, a method provides a service for the automated determination of aptitude or attention level of a user as a function of time of day based on user attributes and external stimuli. The service includes integrating computer-readable program code into a computer system that includes a processor, a computer readable memory in circuit communication with the processor, and a computer readable storage medium in circuit communication with the processor. The processor executes program code instructions stored on the computer-readable storage medium via the computer readable memory and thereby performs the method steps described above, namely determining the impact value relative to the aptitude of the user from the stimulus associated with the event activity, assigning to the determined impact value the negative sign or the positive sign, selecting the at least one baseline time adjustment factor, determining the time shift value, determining the effective time of day value for the current time period of the user within the time of occurrence or the time duration, and generating the effective time of day for the current time of day of the user.

In another aspect, a system has a hardware processor in circuit communication with a computer readable memory and a computer-readable storage medium having program instructions stored thereon. The processor executes the program instructions stored on the computer-readable storage medium via the computer readable memory and thereby determines an impact value relative to an aptitude of a user from a stimulus associated with an event activity that has a time of occurrence and a time duration, as a function one or more of current attributes of the user that include a level of attention, a level of rest and a level of experienced stress. The impact value is assigned a negative sign if beneficial to the user aptitude, or a positive sign if detrimental to the user aptitude. One or more baseline time adjustment factor are selected from a database that each match demographic data of the user and a time value of the event activity time occurrence or the time duration. A time shift value is determined as a sum of all impact values that are determined relative to the aptitude of the user from stimuli associated with event activities having the time of occurrence or the time duration. An effective time of day value is determined for a current time period of the user that is within the time of occurrence or the time duration by adding the determined time shift value to each of the baseline time adjustment factors that match time values within the current time period of the user. Thus, an effective time of day is generated for a current time of day of the user by adding the determined effective time of day value to the current time of day of the user.

In another aspect, a computer program product for the automated determination of aptitude or attention level of a user as a function of time of day based on user attributes and external stimuli has a computer-readable storage medium with computer readable program code embodied therewith. The computer readable program code includes instructions for execution which cause the processor to determine an impact value relative to an aptitude of a user from a stimulus associated with an event activity that has a time of occurrence and a time duration, as a function one or more of current attributes of the user that include a level of attention, a level of rest and a level of experienced stress. The impact value is assigned a negative sign if beneficial to the user aptitude, or a positive sign if detrimental to the user aptitude. One or more baseline time adjustment factor are selected from a database that each match demographic data of the user and a time value of the event activity time occurrence or the time duration. A time shift value is determined as a sum of all impact values that are determined relative to the aptitude of the user from stimuli associated with event activities having the time of occurrence or the time duration. An effective time of day value is determined for a current time period of the user that is within the time of occurrence or the time duration by adding the determined time shift value to each of the baseline time adjustment factors that match time values within the current time period of the user. Thus, an effective time of day is generated for a current time of day of the user by adding the determined effective time of day value to the current time of day of the user.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is a flow chart illustration of a method or process layers for the automated determination of aptitude or attention level of a user as a function of time of day based on user attributes and external stimuli according to an embodiment of the present invention.

FIG. 5 is a spreadsheet illustration of an example of an automated determination of aptitude or attention level of a user as a function of time of day based on user attributes and external stimuli according to an aspect of the present invention.

FIG. 6 is a graphical depiction of relations over time of values determined according to the present invention.

FIG. 7 is a graphical depiction of relations over time of values determined according to the present invention.

FIG. 8 is a graphical depiction of relations over time of values determined according to the present invention.

FIG. 9 is an illustration of a display screen presentation according to the present invention.

FIG. 10 is a graphical depiction of relations over time of values determined according to the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

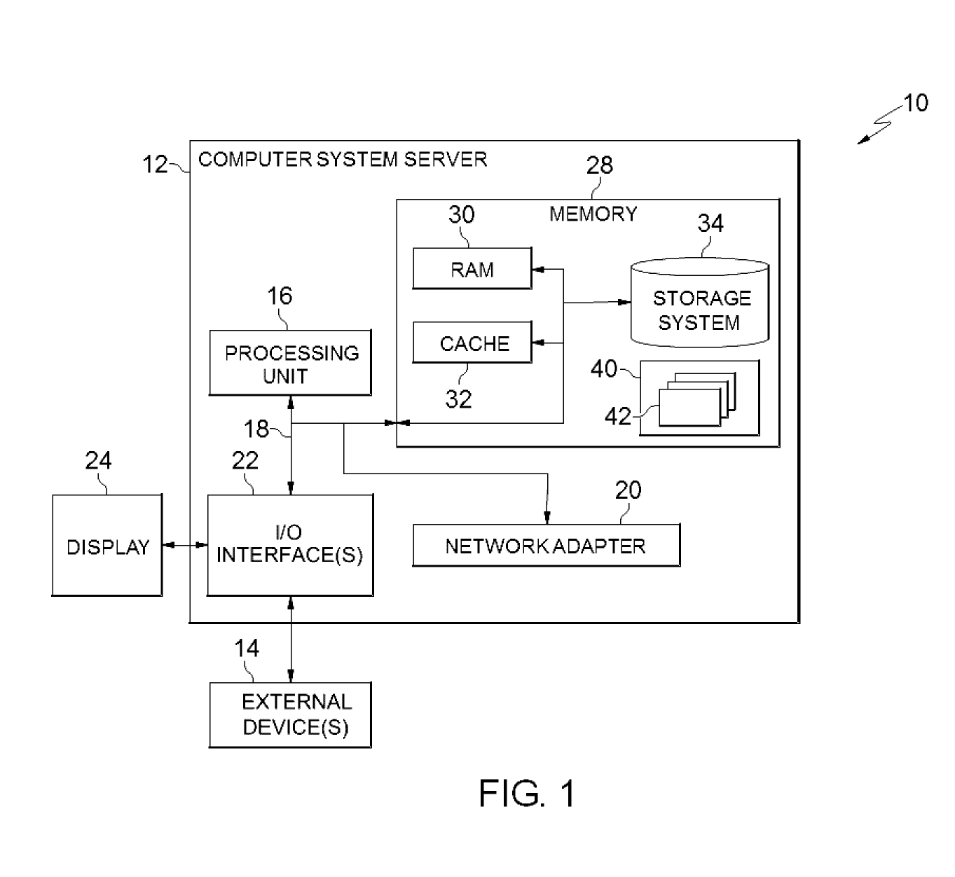

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

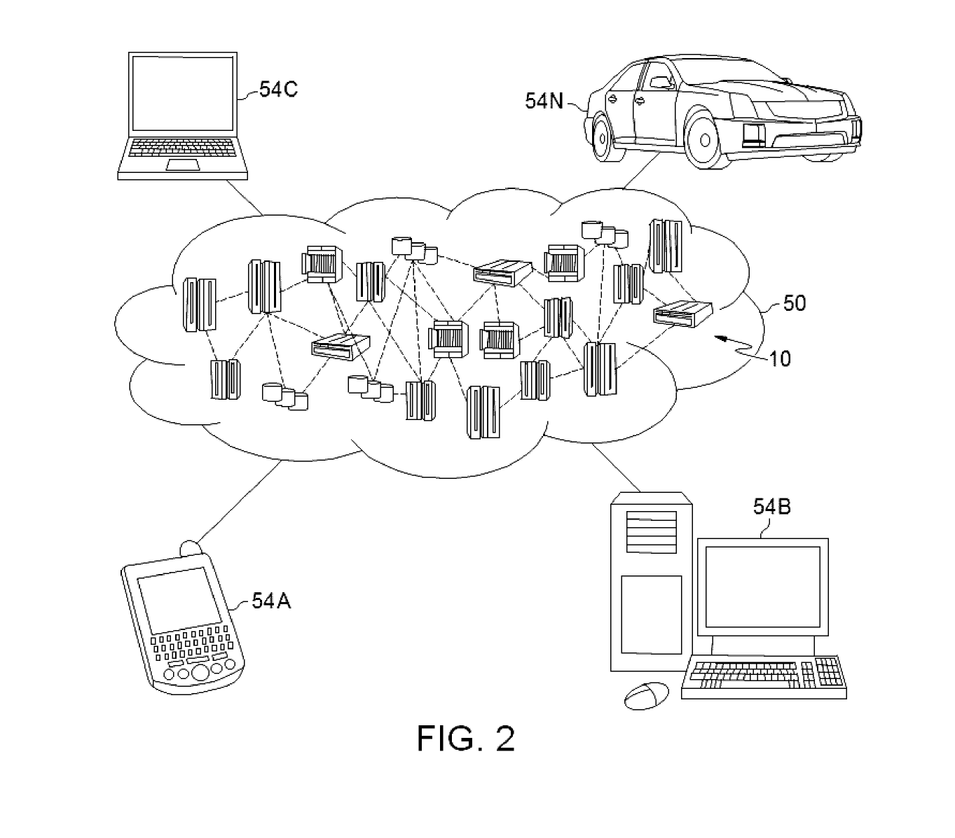

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

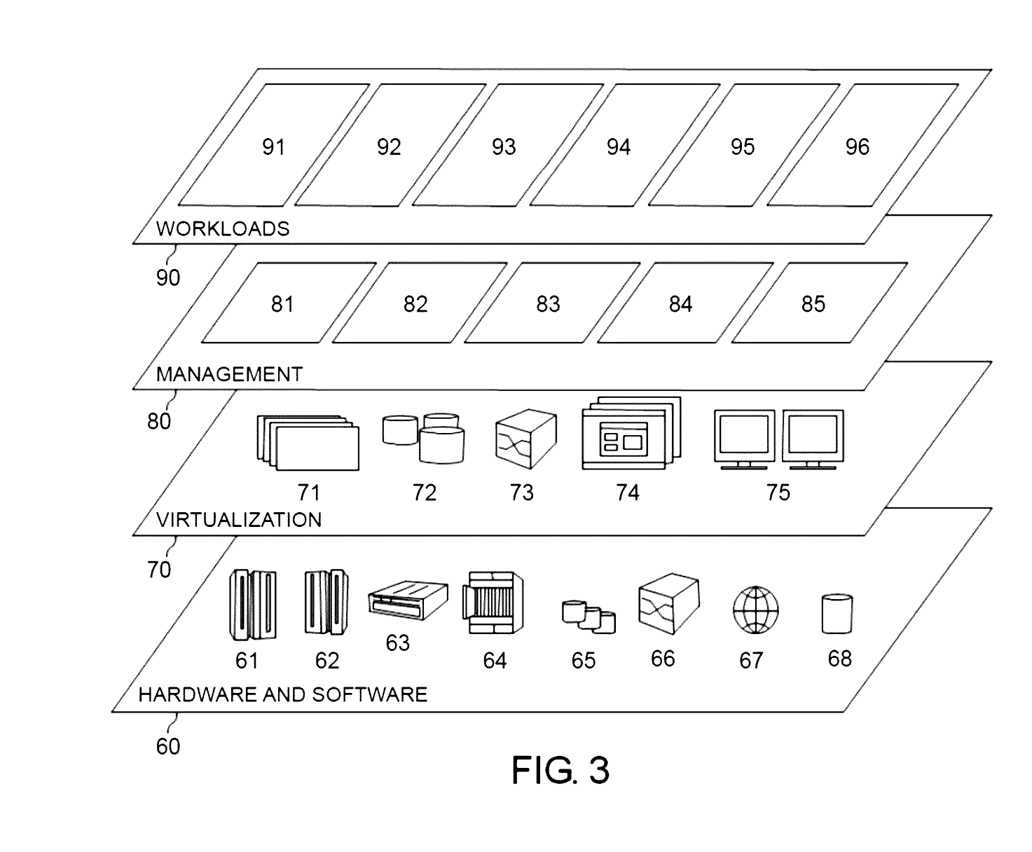

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processes 96 for the automated determination of aptitude or attention level of a user as a function of time of day based on user attributes and external stimuli, as discussed with more particularity below.

In one aspect, a service provider may perform process steps of the invention on a subscription, advertising, and/or fee basis. That is, a service provider could offer to integrate computer readable program code into the computer system/server 12 to enable the computer system/server 12 to perform process steps of the invention. The service provider can create, maintain, and support, etc., a computer infrastructure, such as the computer system 12, bus 18, or parts thereof, to perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 12, from a tangible computer readable medium device 34; (2) adding one or more computing devices to the computer infrastructure 10; and (3) incorporating and/or modifying one or more existing systems 12 of the computer infrastructure 10 to enable the computer infrastructure 10 to perform process steps of the invention.

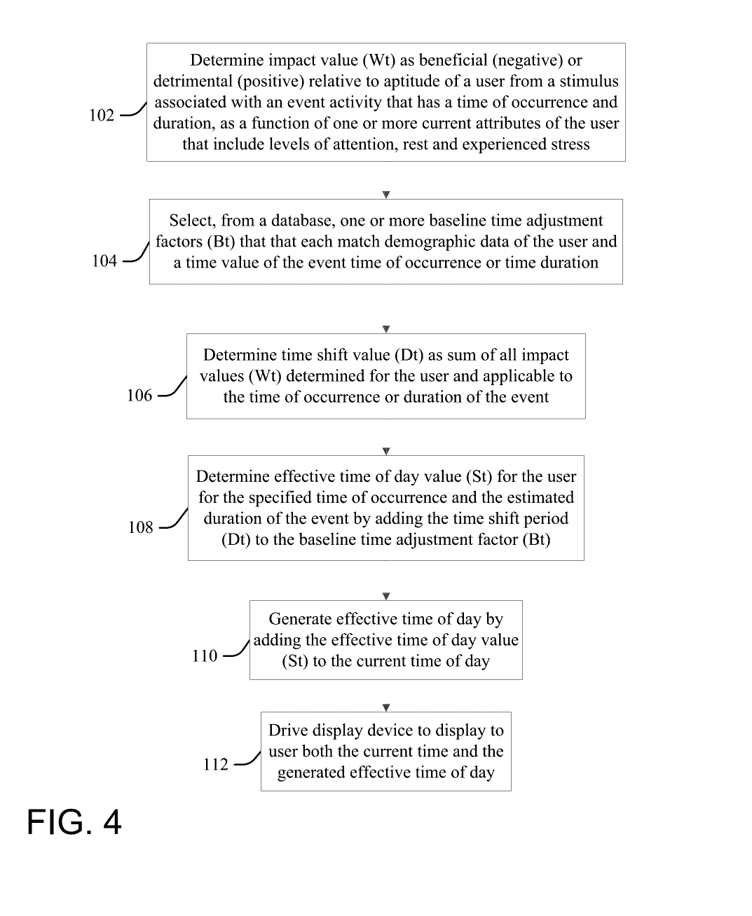

FIG. 4 (or “FIG. 4”) illustrates a computer implemented method or process of an aspect of the present invention for the automated determination of aptitude or attention level of a user as a function of time of day based on user attributes and external stimuli. A processor (for example, a central processing unit (CPU)) executes code (for example, code installed on a storage device in communication with the processor) and thereby performs the steps illustrated in FIG. 4.

Thus, at 102 the processor determines an impact value (sometimes herein denoted as “Wt”) relative to attention, stress level capacity or other aptitude of a user from a stimulus associated with a present or future, upcoming event activity that has a specified time of occurrence (time of day and calendar date) and an estimated time duration of the event. The value is assigned a negative value if the impact is beneficial to said user capacities or aptitudes, and a positive value if the impact is detrimental. These beneficial or detrimental impact values are determined at 102 as a function of one or more of current attributes of the user that include personal aptitudes, abilities and capacities with regard to levels of attention, rest and experienced stress. These current attribute levels may be determined from baseline value indicated from data for demographics of the user (age, sex, socioeconomic status, job description, geographic location (altitude, national health statistics and data, including average sleep hours and expected fitness and sleep patterns of same, etc.) as well as from biometric data that is personal to the user (heart rate monitor data, oxygen levels, medical history, etc.).

The amount of the beneficial impact value is determined as proportionate to positive impact on the attention and stress level capacity, or other attributes of the user. For example, an enjoyable activity that is likely to have a stress-reducing or restorative effect on the user, such as a break from the work day for a lunch appointment with a loved one, is determined to have a beneficial amount of impact in proportionate relation to the remainder of work day hours scheduled for the user.

Similarly, the detrimental impact value is determined at 102 as proportionate to expected amount of reduction in the attention level or capacity of the user, or addition to stressors projected as already imposed on the user by other tasks scheduled or regularly executed by the user during a present work day spanning the baseline time and the duration of the event, and still other relative or proportionate impacts on attributes of the user may be considered. For example, a business meeting that requires a complex mental exertion may have a value determined as a function of user demographic and/or biometric data. An event that has a substantial (threshold) risk or reward exposure associated with performance and attention efforts expended by the user as assessed by a client, manager, co-worker, etc., may be given a default fixed value, or one determined in proportion to current user status, for example halving the value if the user is well rested, or doubling the value if the user biometrics or schedule show the user is under a higher than normal burden or evidencing lower than normal physical health metrics. A taxing activity that is likely to be physically exhausting and require some future time period of rest or recovery to replenish the stress-handling and energy output capacity of the user, to some minimal or baseline rested and ready state, may also be assigned a value as a function of user demographic and/or biometric data.

At 104 one or more baseline time adjustment factors (sometimes herein denoted as “Bt”) are selected, from a database of baseline time adjustment factors, that each match demographic data of the user and a time value of the event time of occurrence or time duration. Baseline time adjustment factors are selected by matching personal characteristics or demographics of the user to other users via sharing similar demographic data, such as age, family status, socioeconomic status, job descriptions and responsibilities, etc., and represents an average or expected level of aptitude (or adjustment thereto) of the user at any given time of day.

The baseline time adjustment factor or factors is/are selected in association with the current time zone that the user is presently residing within, or in association with a different time zone, or span of multiple time zones, that the user is anticipated to be in at the specified time of occurrence and throughout the estimated duration of the event. For example, the user may be travelling through or scheduled to arrive in a different time zone at said the specified time of occurrence and/or during the estimated duration of the event, wherein multiple time zones may be used to select the baseline time adjustment factor associated with the specified time of occurrence and the estimated duration of the event.

At 106 the processor determines a time shift value or period (sometimes herein denoted as “Dt”) as a function of all impact values (Wt) determined for the user and applicable to the time of occurrence and/or duration of the event. In one aspect, the function is a sum of said applicable Wt values, though other functions may be practiced to determine the Dt value, for example, weighting some Wt value differentially based on current attributes of the user, and summing the weighted values, and still other functions will be apparent to one skilled in the art. The Dt value represents a transformation of the impact values into a net, quantified time shift value that approximates a difference from the current, real-time day and time data that is perceived by the user when taking into account the beneficial or detrimental impacts affecting the user from the known events.

At 108 the processor determines an effective time of day value (sometimes herein denoted as “St”) for the user for the specified time of occurrence and the estimated duration of the event by adding the time shift period (Dt) to the baseline time adjustment factor (Bt). This determination may be based on a current time period of the user that is within the time of occurrence or the time duration, and thereby by adding the determined time shift value to each of the baseline time adjustment factors that match time values within the current time period of the user.

At 110 the processor generates an effective time of day from the current time of day (the current time period of the user) as a function of the effective time of day value (St). In one aspect, this comprises adding the effective time of day value (St) to the current time of day, though other aspects use the St value as a factor to proportionately adjust the perceived time of day. Where the net determined amount of impact of the summed Wt values is positive, signifying a net detrimental effect of all applicable Wt values, the St value will essentially be an increase of the Bt value by said net positive value, thereby increasing the difference in the effective time of day from the current time of day that would otherwise be generated by the Bt value. In contrast, if the net determined amount of impact of the summed Wt values is negative, signifying a net beneficial effect of all applicable Wt values on the user, the St value will essentially be a decrease of the Bt value by said net negative value, thereby decreasing the difference in the effective time of day from the current time of day that would otherwise be generated by the Bt value.

At 112 the processor drives a display device on a mobile device (smart phone, etc.) or other programmable device to display to the user both the current time and the generated effective time of day. In some aspects, the processor also drives the display device to display to the user a graphical display of the relation over time of the baseline time adjustment factors (Bt) to the effective time of day values (St).

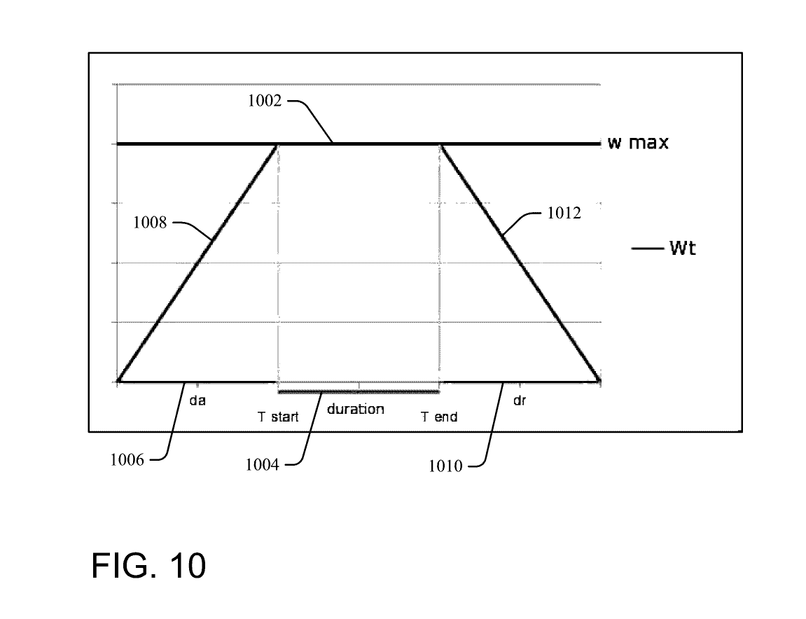

Aspects may use heuristics to dynamically and constantly interpret stimuli and user behavior data inputs to calculate Wt impact values. FIG. 10 illustrates an example of determining an impact value Wt for a given event as a function of a relation of the maximum positive or negative maximum impact value of the event (“Wmax” 1002) to an anticipation time period (“da”) 1006, a duration time period 1004 and a residual time period (“dr”) 1010. More particularly, the Wmax occurs over of the duration 1004 of the time of occurrence of the event (from T-start to T-end), and therefore: Wt=Wmax for T-start<t<T-end, wherein “t” is the time.

The impact value Wt is determined to increase from zero to the Wmax during the anticipation period da 1006, wherein the event has not yet started but anticipation of the event has an impact on the user that is less than the impact of the actual event (for example, from anticipation of a dental procedure for a half-hour of travel time to the dentist, or while waiting in the waiting room for the appointment to begin. In one example, illustrated by the curve portion 1008, Wt=Wmax*(|t−Tstart)|)/(da) for the anticipation period da 1006 (Tstart−da<t<Tstart).

The impact value Wt is determined to decrease from Wmax back to zero over the residual time period dr 1010, wherein the event has finished but continues to have impact on the user that diminishes with time over the residual period (for example, as the user starts to gradually relax and recuperate from the dental procedure after its conclusion). In one example, illustrated by the curve portion 1012, Wt=Wmax*(|Tend+dr−t)|)/(dr), for the residual period dr 1010 Tend<t<Tend+dr.

It will be appreciated that the anticipation and residual time period lengths and the form of the respective curve portions 1008 and 1012 will vary between different events.

Prior art mobile devices may selectively filter alerts, calls or messages presented to a user based on simple user settings, preferences and modes, such as via a “Do not disturb” mode that silences most or all incoming calls, messages or alerts until the mode is unselected or terminated by a manual input of the user, or at a predefined time, such as the beginning of a workday. Prior art spam filter settings can prevent excess messaging reception and alerts, and privacy settings may specify designated subsets of possible originating persons or entities (companies, organizations, domains, etc.). However, such teachings simply reduce totals and kinds of messages and appointments, without consideration of customized impact on a given user. Aspects of the present invention enable the mobile device to move beyond the simple filtering of messages and alerts based on generic user preference and time settings to differentially managing the flow and scheduling within the workday of events based on the effect of stimulus data associated with the events on the personal, current state of the user.

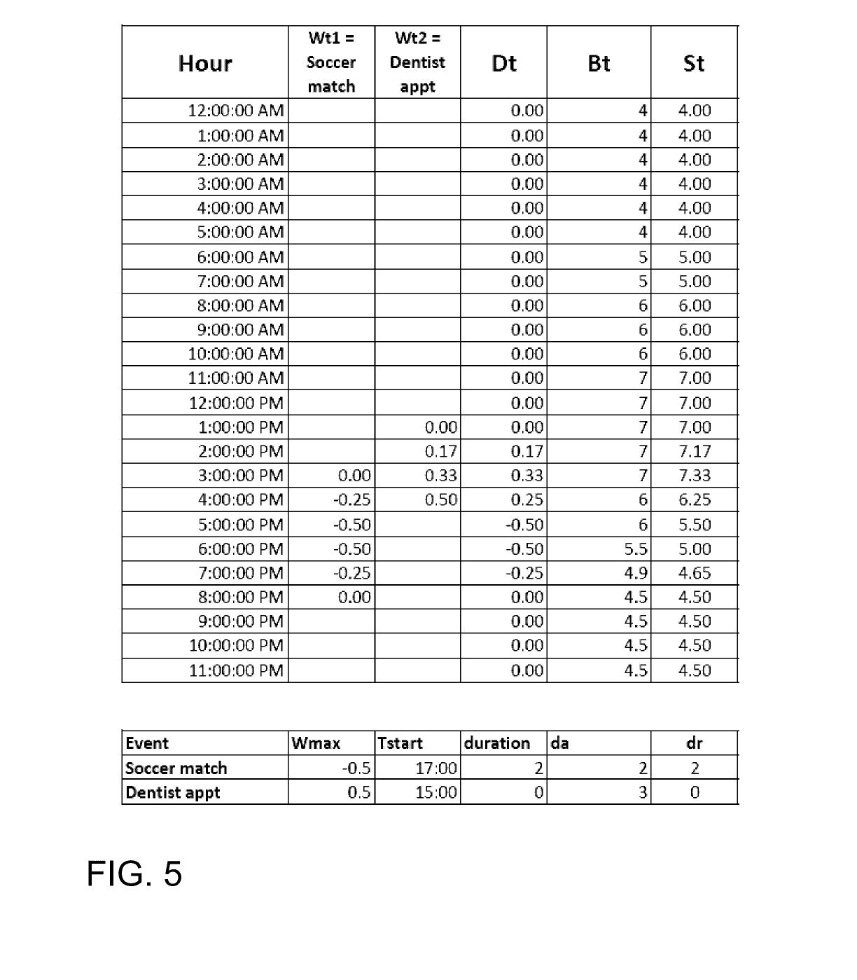

FIG. 5 is a spreadsheet illustration of an example of an automated determination of aptitude or attention level of a user as a function of time of day based on user attributes and external stimuli according to the process or system of FIG. 4. FIG. 5 lists baseline time adjustment factors (Bt) applicable to each hour of the 24 hours of a calendar workday for a specific user. The effective time of day (St) for this user for each of the hours of the day is determined by adding the time shift period (Dt) to the baseline time adjustment factors (Bt).

The time shift period (Dt) value for any given hour is determined by combining the impact values (Wt) of all known appointments, events, etc., scheduled for or identified as occurring during that time period (hour). In the present example, two events are identified that have determined impact values. The first is an appointment to watch a soccer match on television with friends that begins after 4:00 PM and is anticipated to end after 7:00 PM, resulting in a series of different “soccer match” impact values (Wt1) allocated to the hours spanning from 3:00 PM to 8:00 PM. Each of the soccer match impact values (Wt1) are negative values, indicating the beneficial nature of the activity on the working capacity of the user for this work day, so that their effect when added to any other impact value Wt to determine the time shift period (Dt) value, or in directly defining the time shift period (Dt) value where no other impact values (Wt) are present within a given hour, is to shift the perceived, effective time of day (St) for this user backward. The user will feel energized and ready to do more work, as if it is earlier in the day.

The second is a dentist appointment scheduled before the soccer match appointment, which results in different “dentist appt.” impact values (Wt2) that each have positive values allocated to the hours spanning from 1:00 PM to 4:00 PM. These positive values indicate the detrimental nature of the activity on the working capacity of the user for this work day, as the anticipation of the dentist appointment, as well as the procedures endured during said appointment, increase stress levels of the user and thereby reduce her or his capacity to accommodate other work appointments that impose stress on the user. The user will feel stressed or exhausted, and have less capability to do the amount of work that he or she would be typically capable of performing at this time of day, thus as if it is actually later in the day.

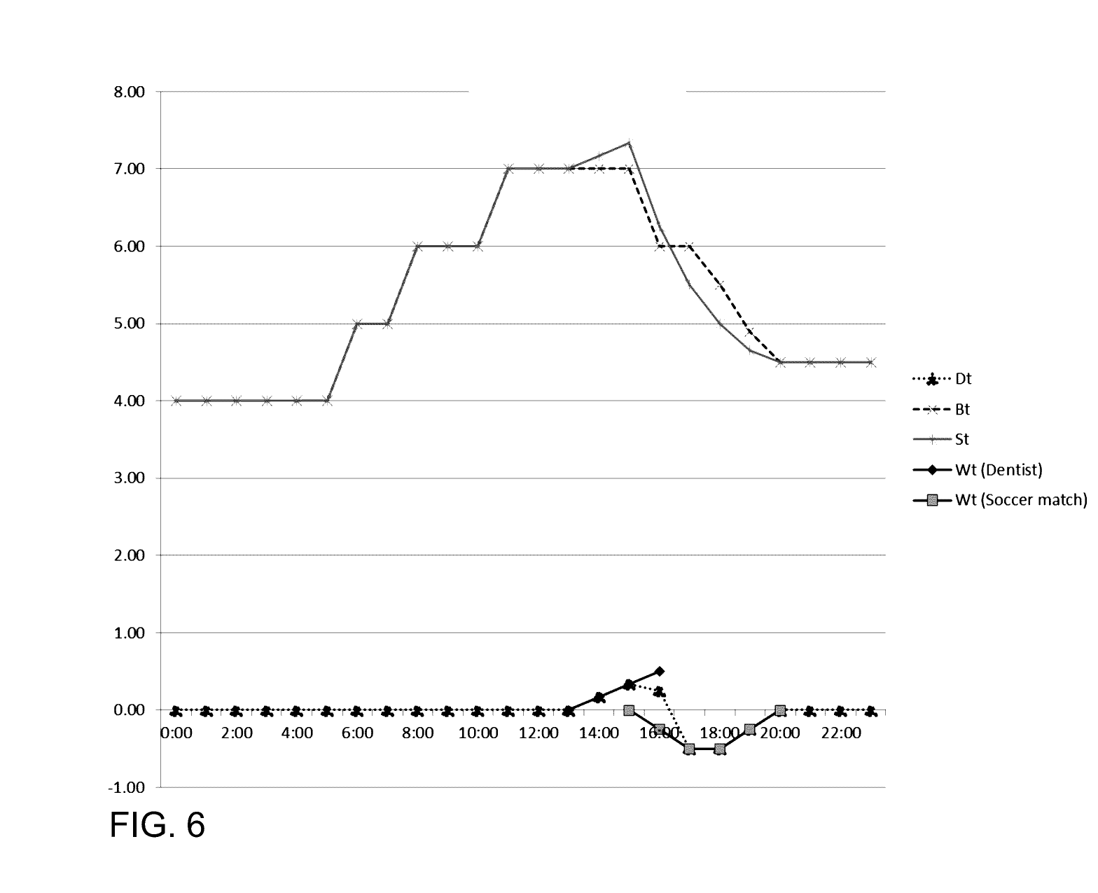

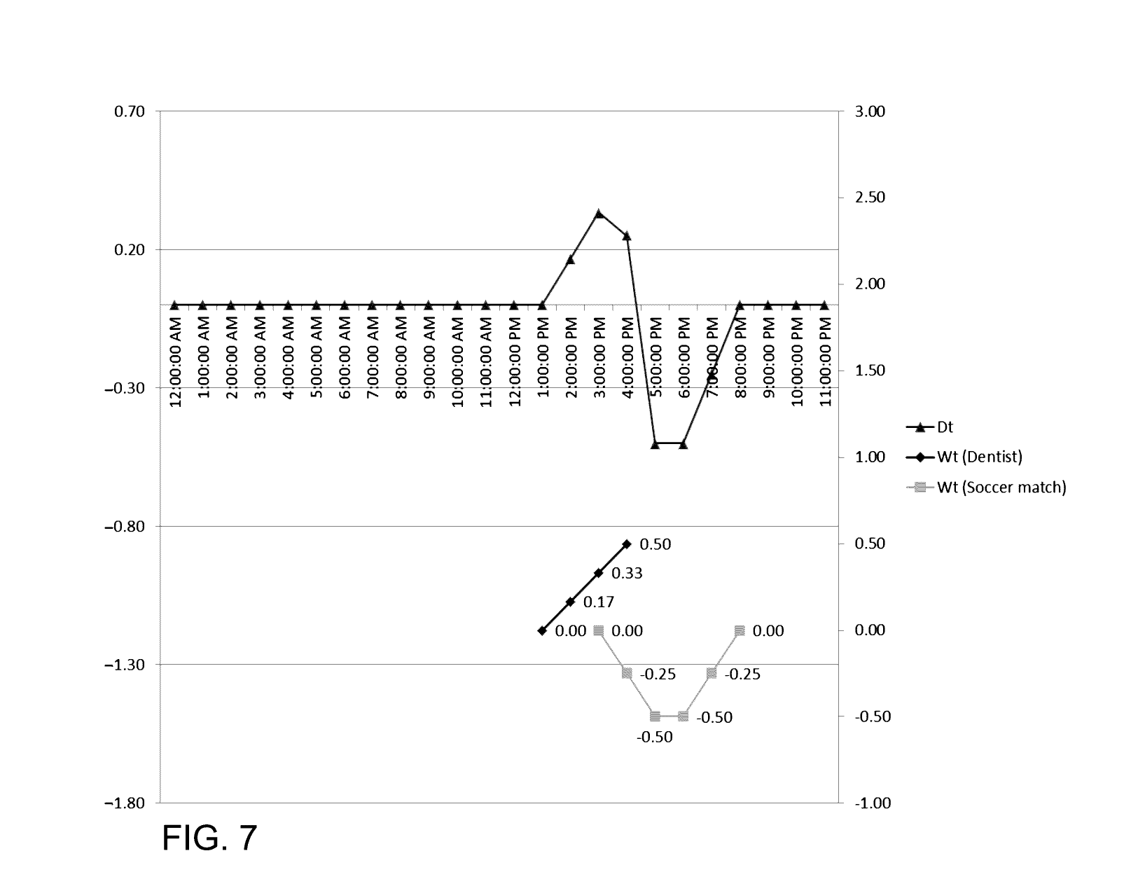

FIG. 6 graphically depicts the relations over time of the values of Bt, St, Dt, Wt1 and Wt2 of the spreadsheet view of FIG. 5. The values of the time shift period (Dt) for each time period is positive for a net detrimental effect on the effective time of day (St) for this user from the combination of all (n) impact values (the sum of (Wt1, Wt2, . . . Wtn), or negative for a net beneficial effect. FIG. 7 is a graphical depiction of the changing value of time shift period (Dt) over time in relation to the values of the soccer match impact value (Wt1) and the dentist appt. impact value (Wt2). (The left vertical axis in FIG. 7 is the value of the time shift period Dt, and the right vertical axis is the scale of value of the impact values Wt).

The value of Bt varies over the course of the day, thereby varying the effect of any given time shift period (Dt) in determining reflecting the effective time of day (St) for this user. Bt values are generally preset baseline values depicting average stress and exertion and other capacity levels defined for the user based on personal and demographic characteristics such as age, family group, body mass index, resting pulse and others.

The progressive drops in Bt as the day moves toward evening in the present example anticipates increased capacity of the user to bear stressors represented by positive Wt impact values (and resultant time shift values Dt) as the day draws to a close. This may be projected from expectations that the anticipation of rest and recuperation at the end of the day will energize the user in the afternoon and thereby increase stressor and work duty capacities. Bt values may also be tied to circadian rhythm data indicating greater capacity for work or bearing stress after 4:00 PM, and progressively increasing as indicated by the progressive lowering of the Bt value toward evening.

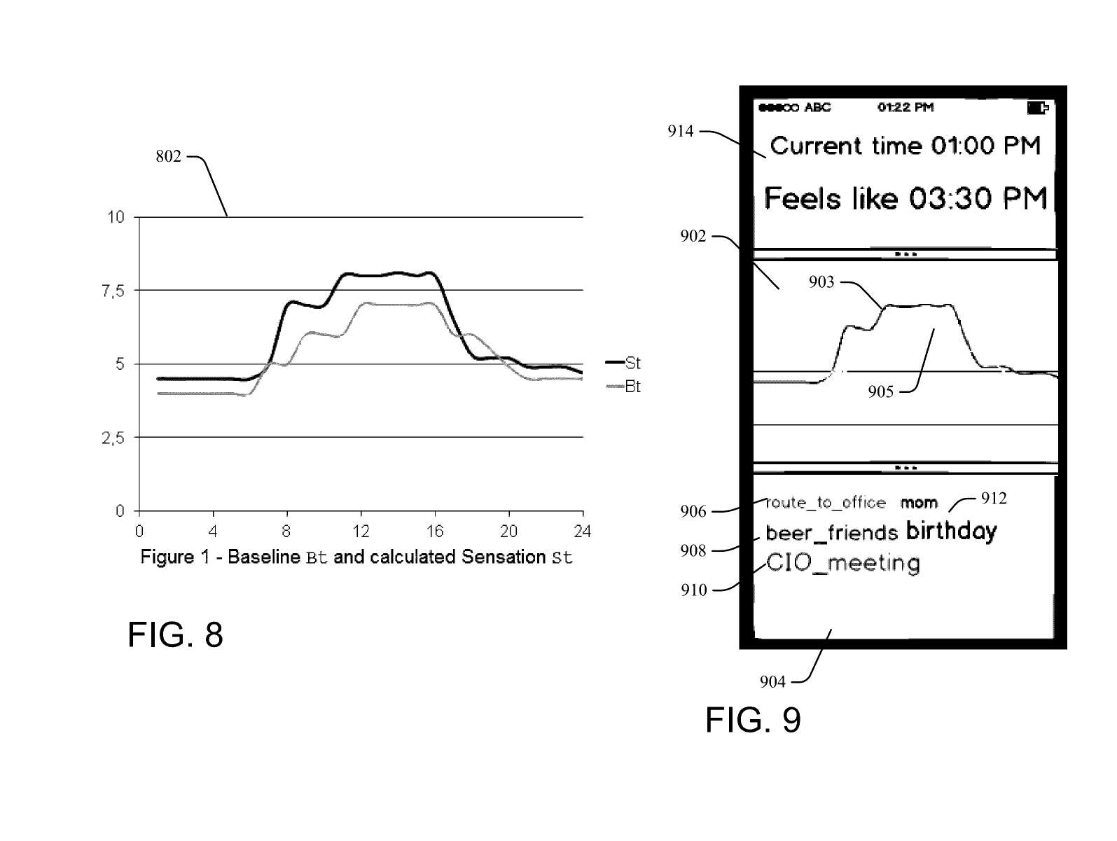

Aspects enhance user's ability to cope with taxing and demanding stimuli, and to decide whether to accept and embrace newer and additional stimuli sources, by giving the user real-time, objective information as to the degree and amount of impact that the new stimuli will present to the user. FIG. 8 is a graphic illustration of a graph 802 that compares the resultant values of the effective time of day (St) for the user defined in the spreadsheet of FIG. 5 (as generated by the net Dt values) over time through the day, in comparison to the baseline time adjustment factor values (Bt) for the user of FIG. 5. As the Bt values represent norms of capacity for the user at any given time, the amount of differences in the values of Bt and St depicted in the graph 802 quickly convey to the user the amount that task and appointment loading for the user on this day diverges from loads associated with the baseline Bt values. Thus, by referring to the displayed graph data 902 the user can quickly ascertain wherein the values of the current or projected effective time of day (St) are above or below the user's baseline, normative Bt values, and decide whether to accept new tasks as proffered, or even triage tasks to determine which ones to drop or accept, based on impacts to the dynamically displayed effective time of day (St) relative to the baseline Bt data.

FIG. 9 depicts a graph 802 that plots Bt values 905 against St values 903 on a display screen 904 of a smart phone or other programmable device, wherein the St data 903 is generated by four appointments or tasks listed on the display 904: a trip to the office 906, a meeting at a bar to have a beer with friends 908, a meeting with the Chief Information Officer (CIO) 910, and a birthday party in the evening for the user's mother 912. A text display 914 informs the user that although the current time is actually 1:00 PM, the effective time (St) is 3:30 PM, indicating the increased loading of stress or exertion on the user from this schedule is relative to a load that would correlate to the baseline Bt values.

Thus, the aspect quickly and clearly conveys the relative amount that current appointments impose more or less stress on the user relative to a baseline norm by simply shifting the real time clock of the user forward or back in proportionate amounts of time, to approximate an “effective time” that the state of the user is existing within relative to the baseline norm. More time shifting amounts indicate more drastic the effect of the current social and work appointment commitments of the user, which may prompt the user to reassess and rebalance the appointment load as needed.

In one example, the user can deselect any one of the appointments 906, 908, 910 and 912, or add another appointment (not shown), wherein the St values will be recalculated and replotted on the display 904 relative to the Bt value plot 905, and the “feels like” text data 914 updated. The user is thereby empowered via a dynamic positive, feedback system to test out different appointment combinations to generate variations in the Bt value plot data 905 and/or “feels like” text data 914 as desired. The user can dynamically match planned activities to projected and determined energy levels as desired, enabling the user to adapt herself or himself to a dynamic, changing schedule, or revise task and work schedules as needed, to bring the St curve into any desired relationship with the Bt curve. The user can also use this information to immediately assess the actual impact on themselves (feelings of exhaustion, stress, work capacity) versus the projected impact of the accepted stimuli on these attributes as conveyed by the Bt value plot data 905 and/or “feels like” text data 914.

Mobile devices according to the present invention may use a variety of physical sensors to measure the psychological and physiological state of the users (for example, heart rate, resting pulse, historical health monitor data, new or recent injury or illness report data for the user, etc.), and in some examples to thereby revise Bt and Wt/Dt values in response to dynamically refine the data displayed and determined.

Aspects transform biometric data and other measurements of behavior and stimuli impacts in the physical domain into a different, psychological realm domain, transforming physical stress into an abstract, time-perception domain. Transforming this data into this other domain enables a different type of feedback mechanism. Rather than simply trying to bring down the user's heartrate, appointment commitments may be altered to instead reduce, forward time shifting, thereby indirectly reducing stress levels that may be determined by other metrics unrelated to a simple heart rate feedback. Furthermore, by observing the variations in time shifting achieved by different scheduling approaches, as well as comparing how the user actually feels to the determined effective or perceived time of day (St), aspects provide modelling that enables the indirect prediction of stress levels and a new range of functionality in scheduling assistance to minimize negative impact and/or encourage recovery. The user may adapt his or her agenda with the objective of optimally managing stress levels without directly considering stress data.

Events considered as inputs associated with impact values (Wt) may be generated by a variety of stimuli or detected user behavior. Examples include user interactions with a device, including application usage and device screen unlock patterns. Externally triggered inputs include incoming messages, Simple Message System (SMS), email, instant messaging, phone calls, alerts, etc. Inbox backlog data, such as the amount of pending messages in the inbox relative to a threshold, may be assigned proportionate impact values (Wt). Agenda event descriptions may be used to determine impact values for events. Global Positioning Satellite (GPS) data and social media “check-ins” may identify travel or location activity or sites, for example, identifying work commuting or pleasure trips or location arrivals and departures via driving information and assigning impact values accordingly. Typing error correction rates, weather information and sleep cycle information harvested from devices may also be used to update baseline or impact values.

Defining category for a given user event may be determined by a series of characteristics including event identification indicia and associated modifying variables. For example, for incoming message and phone call events the associated modifying variables include indicia of originating group or contact, such as family member, work contact, social network favorite, etc. The Wmax value will be different for an incoming call from a relative as compared to one from a coworker, or between a personal email and an electronic bank bill email.

Events may be distinguished as based on personal or business agendas and events. Wmax values will be different based on different social, personal or recreational activities, such as watching a soccer match with friends, as compared with a doctor appointment or a business meeting.

GPS driving information data may also be associated with commute time variables that include the amount of hours driving on a trip, and traffic and road status information. Busy roads or traffic construction resulting in a delayed commute would have a greater negative impact on the user, generally increasing Wmax, or extending length of residual time period used to diminish the Wmax back to zero, or changing the rate at which Wmax decreases over the residual period.

The location of an event (as determined from GPS or social media “check-in” services) may indicate differentiated categories for events, wherein restaurant-located events may have different impact valuations from other social activity locations (cinema, bar, coffee shop) as well as from work-related locations (office, client site, supplier site, legal or accounting services).

Shifting the effective or perceived time of day (St) for the user backwards proportionately enables a mobile device or other programmable device to automatically schedule additional works appointments over the same time frame for this day that require effort, increase stress, etc., and thus have positive/detrimental effect impact values (Wt), while shifting the effective/perceived time of day (St) forwards may proportionally stop the automatic scheduling of those additional works appointments that require effort, increase stress, etc., and thus have the positive/detrimental effect impact values (Wt). Thus, their effect when added to any other impact value Wt to determine the time shift period (Dt) value, or in directly defining the time shift period (Dt) value where no other impact values (Wt) are present within a given hour, is to shift the perceived, effective time of day (St) for this user forward, to end or recommend against the additional scheduling of more work-related or other stressor events that may extend the perceived/effective work day beyond a specified endpoint.

In one example, the user of the aspect described above with respect to FIGS. 4-9 specifies that 7:00 PM is the end of his or her workday, and therefore for the automatic scheduling of appointments by a programmable device as a function of the determined effective time of day (St). Thus, appointments for this user cannot be added if they are detrimental to the user capabilities (have positive Wt values) and result in an St that exceeds 7:00 PM without override by the user. Alternatively, the device could suggest another positive activity (having negative Wt values) before that time to reduce the St, to replenish the user and enable the user to meet the current obligations within an effective St of no later than 7:00 PM

Referring again to the spreadsheet of FIG. 5, for this user the lowest or threshold value of Bt is “4” over the hours from 12:00 AM to 06:00 AM, the start of the user's workday, or commute, or beginning of other activities. Where the work day has a specified endpoint 7:00 PM, this means that the user can accommodate automatic scheduling before 6:00 AM that results in a maximum positive time shift period (Dt) of “3,” as any higher number when added to the baseline value of “4” will cause the maximum perceived effective time of day (St) to exceed 7:00 PM. Thus, this user has the greatest capacity for accepting appointments resulting in a net positive (detrimental) impact value (Dt) during the overnight hours, and prior to 6:00 AM.

From 6:00 AM to 8:00 AM the Bt rises to “5,” meaning that the user can accommodate Dt values of up to two hours (“2”). This may reflect efforts expended in traveling to a workplace during this time period, or other duties at work, etc., that reduce the user capacity for additional detrimental work by the value of “1” relative to the earlier time periods. From 8:00 AM to 11:00 AM the Bt rises to “6”, meaning that the user can accommodate Dt values of up to only one hour (“1”), perhaps reflecting the projected effects on the worker of the efforts expected from this user in meeting the demands of the workday through this later time period.

At 11:00 AM through 4:00 PM no new events/meetings can be scheduled that would result in a net positive Dt value, as the Bt is “7” for these hours, resulting in a perceived time of day that would push past 7 PM for any positive Dt value. This reflects that the user is expected to be already scheduled with tasks requiring efforts at a recommended capacity of performance and efficiency.

During 4:00 PM-6:00 PM the Bt value is lowered to “6,” and therefore the user's schedule is now again open for new appointments that result in a net positive Dt value of no more than “1”. Further, during the last hour at the end of the workday (6:00 PM-7:00 PM) the Bt value is again lowered to “5.5,” signifying that the user schedule is open for an additional detrimental task or appointment that pushes the net positive Dt value to no more than “1.5.” For the first hour at the end of the workday (7:00 PM) the Bt value drops again, to “4.9.” Then for the remainder of the day (from 8:00 PM through 11:00 PM) the Bt value drops to “4.5.”

In some examples, a buffer overtime period (for example, two (2) hours or some other value selected by one skilled in the art) may apply, allowing the St to exceed the end of the day (7 PM) by that margin, perhaps conditional on confirmation in reply to a message to the user. For example, “John has requested a meeting that will take you one hour beyond your effective end of day, do you want to accept?”

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for the automated determination of aptitude or attention level of a user as a function of time of day based on user attributes and external stimuli, the method comprising executing on a computer processor the steps of:
determining an impact value relative to an aptitude of a user from a stimulus associated with an event activity that has a time of occurrence and a time duration, as a function of at least one of current attributes of the user that comprise a level of attention, a level of rest and a level of experienced stress;
assigning to the determined impact value a negative sign in response to determining that the impact of the event activity is beneficial to the user aptitude, and a positive sign in response to determining that the impact of the event activity is detrimental to the user aptitude;
selecting at least one baseline time adjustment factor from a database of baseline time adjustment factor that each match demographic data of the user and a time value of the event activity time of occurrence or time duration;
determining a time shift value as a sum of all impact values that are determined relative to the aptitude of the user from stimuli associated with event activities having the time of occurrence or the time duration;
determining an effective time of day value for a current time period of the user that is within the time of occurrence or the time duration by adding the determined time shift value to each of the baseline time adjustment factors that match time values within the current time period of the user; and
generating an effective time of day for a current time of day of the user by adding the determined effective time of day value to the current time of day of the user.

2. The method of claim 1, further comprising:
integrating computer-readable program code into a computer system comprising the processor, a computer readable memory in circuit communication with the processor, and a computer readable storage medium in circuit communication with the processor; and
wherein the processor executes program code instructions stored on the computer-readable storage medium via the computer readable memory and thereby performs the steps of determining the impact value relative to the aptitude of the user from the stimulus associated with the event activity, assigning to the determined impact value the negative sign or the positive sign, selecting the at least one baseline time adjustment factor, determining the time shift value, determining the effective time of day value for the current time period of the user within the time of occurrence or the time duration, and generating the effective time of day for the current time of day of the user.

3. The method of claim 1, wherein the at least one current attribute of the user used to determine the impact value from the stimulus associated with the event activity is a current attribute level determined from a baseline value that matches demographic data of the user.

4. The method of claim 3, wherein the demographic data of the user is at least one of age, sex, socioeconomic status, job description, geographic location and biometric data.

5. The method of claim 1, further comprising:
driving a display device in communication with the processor to display to the user both the current time and the generated effective time of day.

6. The method of claim 5, wherein the step of determining the impact value comprises:
determining a maximum impact value for a duration time period that matches the event activity duration;
determining an anticipation impact value that progressively increases from zero to the maximum impact value over an anticipation period of time that is prior to the duration time period;
determining a residual impact value that progressively decreases from the maximum impact value to zero over a residual period of time that is subsequent to the duration time period; and
determining the impact value as a function over time of corresponding values of the maximum impact value, the progressively increasing anticipation impact value and the progressively decreasing residual impact value.

7. The method of claim 5, further comprising:
in response to determining that the generated effective time of day exceeds a specified end of workday time for the user:
rejecting a scheduling of the event activity on an agenda of the user; or
scheduling another event activity on the agenda of the user that has a negative impact value, wherein the determined time shift value is revised to a revised time shift value by including the negative impact value of the another event activity into the sum of impact values, and a revised effective time of day value that is determined for the current time period of the user by adding the revised time shift value to each of the baseline time adjustment factors that match the time values within the current time period of the user that does not exceed the specified end of workday time for the user.

8. The method of claim 5, further comprising:
driving the display device to display to the user a graphical display of a relation over time of the at least one baseline time adjustment factor to the effective time of day value.

9. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
determines an impact value relative to an aptitude of a user from a stimulus associated with an event activity that has a time of occurrence and a time duration, as a function of at least one of current attributes of the user that comprise a level of attention, a level of rest and a level of experienced stress;
assigns to the determined impact value a negative sign in response to determining that the impact of the event activity is beneficial to the user aptitude, and a positive sign in response to determining that the impact of the event activity is detrimental to the user aptitude;
selects at least one baseline time adjustment factor from a database of baseline time adjustment factor that each match demographic data of the user and a time value of the event activity time of occurrence or time duration;
determines a time shift value as a sum of all impact values that are determined relative to the aptitude of the user from stimuli associated with event activities having the time of occurrence or the time duration;
determines an effective time of day value for a current time period of the user that is within the time of occurrence or the time duration by adding the determined time shift value to each of the baseline time adjustment factors that match time values within the current time period of the user; and
generates an effective time of day for a current time of day of the user by adding the determined effective time of day value to the current time of day of the user.

10. The system of claim 9, wherein the at least one current attribute of the user used to determine the impact value from the stimulus associated with the event activity is a current attribute level determined from a baseline value that matches demographic data of the user; and
wherein the demographic data of the user is at least one of age, sex, socioeconomic status, job description, geographic location and biometric data.

11. The system of claim 9, wherein the processor executes the program instructions stored on the computer-readable storage medium via the computer readable memory and thereby further:
drives a display device in communication with the processor to display to the user both the current time and the generated effective time of day.

12. The system of claim 11, wherein the processor executes the program instructions stored on the computer-readable storage medium via the computer readable memory and thereby further:
determines a maximum impact value for a duration time period that matches the event activity duration;
determines an anticipation impact value that progressively increases from zero to the maximum impact value over an anticipation period of time that is prior to the duration time period;
determines a residual impact value that progressively decreases from the maximum impact value to zero over a residual period of time that is subsequent to the duration time period; and
determines the impact value as a function over time of corresponding values of the maximum impact value, the progressively increasing anticipation impact value and the progressively decreasing residual impact value.

13. The system of claim 11, wherein the processor executes the program instructions stored on the computer-readable storage medium via the computer readable memory and thereby further, in response to determining that the generated effective time of day exceeds a specified end of workday time for the user:
rejects a scheduling of the event activity on an agenda of the user; or
schedules another event activity on the agenda of the user that has a negative impact value, wherein the determined time shift value is revised to a revised time shift value by including the negative impact value of the another event activity into the sum of the impact values, and a revised effective time of day value that is determined for the current time period of by adding the revised time shift value to each of the baseline time adjustment factors that match the time values within the current time period of the user does not exceed the specified end of workday time for the user.

14. The system of claim 11, wherein the processor executes the program instructions stored on the computer-readable storage medium via the computer readable memory and thereby further:
drives the display device to display to the user a graphical display of a relation over time of the at least one baseline time adjustment factor to the effective time of day value.

15. A computer program product for the automated determination of aptitude or attention level of a user as a function of time of day based on user attributes and external stimuli, the computer program product comprising:
a computer readable storage medium having computer readable program code embodied therewith, wherein the computer readable storage medium is not a transitory signal per se, the computer readable program code comprising instructions for execution by a processor that cause the processor to:
determine an impact value relative to an aptitude of a user from a stimulus associated with an event activity that has a time of occurrence and a time duration, as a function of at least one of current attributes of the user that comprise a level of attention, a level of rest and a level of experienced stress;
assign to the determined impact value a negative sign in response to determining that the impact of the event activity is beneficial to the user aptitude, and a positive sign in response to determining that the impact of the event activity is detrimental to the user aptitude;
select at least one baseline time adjustment factor from a database of baseline time adjustment factor that each match demographic data of the user and a time value of the event activity time of occurrence or time duration;
determine a time shift value as a sum of all impact values that are determined relative to the aptitude of the user from stimuli associated with event activities having the time of occurrence or the time duration;
determine an effective time of day value for a current time period of the user that is within the time of occurrence or the time duration by adding the determined time shift value to each of the baseline time adjustment factors that match time values within the current time period of the user; and
generate an effective time of day for a current time of day of the user by adding the determined effective time of day value to the current time of day of the user.

16. The computer program product of claim 15, wherein the at least one current attribute of the user used to determine the impact value from the stimulus associated with the event activity is a current attribute level determined from a baseline value that matches demographic data of the user; and
wherein the demographic data of the user is at least one of age, sex, socioeconomic status, job description, geographic location and biometric data.

17. The computer program product of claim 15, wherein the computer readable program code instructions for execution by the processor further cause the processor to drive a display device in communication with the processor to display to the user both the current time and the generated effective time of day.

18. The computer program product of claim 17, wherein the computer readable program code instructions for execution by the processor further cause the processor to:
determine a maximum impact value for a duration time period that matches the event activity duration;
determine an anticipation impact value that progressively increases from zero to the maximum impact value over an anticipation period of time that is prior to the duration time period;
determine a residual impact value that progressively decreases from the maximum impact value to zero over a residual period of time that is subsequent to the duration time period; and
determine the impact value as a function over time of corresponding values of the maximum impact value, the progressively increasing anticipation impact value and the progressively decreasing residual impact value.

19. The computer program product of claim 17, wherein the computer readable program code instructions for execution by the processor further cause the processor to, in response to determining that the generated effective time of day exceeds a specified end of workday time for the user:
reject a scheduling of the event activity on an agenda of the user; or
schedule another event activity on the agenda of the user that has a negative impact value, wherein the determined time shift value is revised to a revised time shift value by including the negative impact value of the another event activity into the sum of the impact values, and a revised effective time of day value that is determined for the current time period by adding the revised time shift value to each of the baseline time adjustment factors that match the time values within the current time period of the user that does not exceed the specified end of workday time for the user.

20. The computer program product of claim 17, wherein the computer readable program code instructions for execution by the processor further cause the processor to drive the display device to display to the user a graphical display of a relation over time of the at least one baseline time adjustment factor to the effective time of day value.
